(19) United States
(12) Patent Application Publication
(10) Pub. No.: US 2002/0003393 A1
(43) Pub. Date: Jan. 10, 2002

(54) Colour display tube with improved suspension of the colour selection electrode

(76) Inventors: Jorg Meissner, Eindhoven (NL); Jan Harmannus Post, Eindhoven (NL); Hernes Jacobs, Breda (NL)

Correspondence Address: U.S. Philips Corporation, 580 White Plains Road, Tarrytown, NY, 10591, US

(21) Appl. No.: 09/853,938

(22) Filed: May 10, 2001

(30) Foreign Application Priority Data
May 11, 2000 (EP) 00201683.0

(51) Int. Cl. H01J 29/80

(52) U.S. Cl. 313/404

(57) ABSTRACT

A color display tube (1) is disclosed with an improved suspension system of the color selection electrode (12). The color display tube has suspension means that have a self-locking construction. The suspension means (20) are provided with an additional flat portion (31). This plate has an aperture (32) that is shaped such that it has at least three surfaces of engagement (42, 43) for the free end portion (22) of the supporting elements (17) which are connected to the inside of the upright edge (18) of the display window (3). When the color display tube is exposed to a shock the construction of the flat portion (31) is capable of absorbing this shock without the color selection electrode (12) coming down from the supporting elements (17). The action is based on the friction between the surfaces of engagement (42) and the free end portion (22). When a force is applied in the plane (47) of the resilient element (30), the suspension means (20) slip off from their rest position and are locked by a surface of engagement (48), the preload caused by the resilient element (30) and the spring (40) will reposition the suspension means (20) to its original position. A color display tube (1) results with good positional stability of the color selection electrode (12). Further, the color selection electrode (12) can be reclaimed in case the color display tube (1) is rejected because there is no need to weld the suspension means (20) to the free end portions (22) anymore.

The invention relates to a colour display tube comprising a display window with a circumferential upright edge and corner areas, a colour selection electrode comprising corner sections to which suspension means, comprising a resilient element having a flat portion incorporating an apertured part with an entrance opening, are coupled, which colour selection electrode is suspended in the corner areas from supporting elements each having a free end portion engaging the apertured part at at least three contact points which are located on surfaces of engagement, the free end portion having a centre which is substantially coinciding with a plane through the flat portion, the apertured part being so formed that at least one of the contact points is situated out of the plane of the flat portion, on the side thereof directed away from the free end portion.

The invention also relates to a corner section for use in a colour selection electrode of such a colour display tube and to a colour selection electrode provided with such a corner section.

A colour display tube as described in the opening paragraph is disclosed in the U.S. Pat. No. 4,763,039. The colour display tube according to this specification is provided with a colour selection electrode, which is suspended in the comers of the display window. In this corner suspension system the supporting elements, connected in the comers of the upright edge of the display window, are coupled to the suspension means of the colour selection electrode. The suspension means comprise a flat portion, the resilient element, and a part with an aperture for receiving the spherically curved free end portion of the supporting elements. This aperture is provided with at least three contact points for engaging the free end portion, of which at least one contact point is situated outside the plane of the resilient element. Further, the part containing the aperture is provided with a member that acts as a spring to lock the spherically curved free end portion in the aperture of the suspension means. So, the aperture and free end portion act as a detent, locking the individual suspension means to the supporting elements.

The colour selection electrode has to be stably positioned in the colour display tube to ensure that the picture displayed on the display window always shows the right colours. Instabilities of the position of the colour selection electrode lead to misregistrations of the electron beams impinging on the different colours of phosphor. This will cause discolourations of the picture, resulting in a deterioration of the picture quality.

The colour display tube disclosed in U.S. Pat. No. 4,763,039 has the disadvantage that it has a corner suspension system which requires large forces for clamping the suspension means on the supporting elements. This is necessary in order to fulfil a basic requirement of having a colour selection electrode that does not comes free from the supporting elements in a finished colour display tube. However, the high clamping forces lead in the production process to loose particles in the colour display tube by scratching of the spring element along the supporting elements. This high clamping force influences the positional stability of the colour selection electrode in the colour display tube in a negative way because the friction between the supporting elements and the suspension means is considerably increased.

It is an object of the invention to provide a colour display tube having a colour selection electrode with an improved suspension system over the type described in the opening paragraph, which strongly diminishes the registration errors on the display window and which leads to a cheaper production process of colour display tubes in the factories.

According to the present invention, this object is realized with a colour display tube which is characterized in that the surfaces of engagement of contact points that coincide with the plane through the flat portion are substantially perpendicular to said plane and the surfaces of engagement of contact points that are situated out of said plane are substantially perpendicular to the connection between the contact point and the centre of the free end portion, which free end portion is suitable for freely passing the entrance opening of the apertured part.

The invention is based on the insight that by having an entrance opening of the apertured part that is slightly larger than the diameter of the free end portion, the mounting of the colour selection electrode becomes quite easy. The colour selection electrode is positioned by pushing the suspension means over the supporting elements thereby only overcoming the spring force of the resilient elements. The surface of engagement containing a contact point situated outside the plane through the flat portion makes sure the free end portion is positioned with its centre substantially coinciding with the flat portion. Mechanical shocks exerted on the colour display tube can shift the colour selection electrode with respect to the display window, but the positioning of the surfaces of engagement in combination with the preload of the springforce of the resilient elements makes that the colour selection element will be repositioned to its original situation. This makes that the colour display tube will not suffer from misregistrations, thereby improving the picture quality.

Further, because this construction realizes a very stable positioning of the colour selection electrode, it becomes superfluous to weld the suspension means to the supporting elements as is done in currently produced colour display tubes. This makes it possible to reclaim the colour selection electrode in case of a reject of a colour display tube and reuse it for the production of another colour display tube, leading to a significant saving in the production centre.

In a preferred embodiment the apertured part being so formed that the coupling between the apertured part and the free end portion is self-locking for forces applied in the direction of the flat portion.

Mechanical shocks exerted to the colour display tube lead to a force in the suspension element that has its direction in the flat portion containing the resilient element. In order to prevent that the colour selection electrode comes of from the supporting elements, it is of importance that a self-locking action exists in the direction of the flat portion. For that reason, the surfaces of engagement of the apertured part are so arranged that in case a force is applied that is directed in the plane of the flat portion, a shift may occur between the suspension means and the supporting element, but when this force extincts the original position is resumed. In the direction perpendicular to the flat portion a self locking action is unwanted, because this makes the handling in the production process more difficult. During the manufacture of a colour display tube the display window is provided—by a photochemical exposure process—with a screen comprising, for instance, a black matrix layer and three colours of phosphor. For the exposure of each of them the colour selection electrode has to be inserted and extracted from the display window. This is most easily done when in the direction perpendicular to the flat portion no obstructions between the suspension means and the free end portion are present.

In a further embodiment a friction force arises between the surfaces of engagement of the contact points that are situated out of the plane of the flat portion and the free end portion when a force is applied in the direction of the flat portion.

When a force is applied in the direction of the plane of the flat portion, the surfaces of engagement of which the contact points are situated in this plane will have no friction force between them and the free end portions, because the applied force is perpendicular to these surfaces of engagement. However, the surfaces of engagement of the contact points that are out of the plane of the flat portion are not perpendicular to the applied force, resulting in a friction between these surfaces of engagement and the free end portion. This friction is very important for the self-locking function of the suspension system. If the friction is higher, the self-locking function is maintained for higher applied forces as well.

A still further embodiment is characterized in that one contact point is situated out of the plane of the flat portion and two contact points are coinciding with said plane.

For having a stable coupling between the suspension means and the free end portion, at least three contact points are required. The easiest way to realize this is with exactly three contact points of which only one is situated outside the plane of the flat portion.

In a still further embodiment the free end portions are substantially spherically curved. Free end portions of this shape are preferred because they are easy to manufacture and enable a simple way of designing the positions of the surfaces of engagement.

The invention further relates to a corner section of a colour selection electrode for use in a colour display tube according to the present invention and to colour selection electrodes provided with such corner sections.

These and other aspects of the invention are apparent from and will be elucidated by way of non-limitative examples with reference to the drawings and the embodiments described hereinafter.

In the drawings:

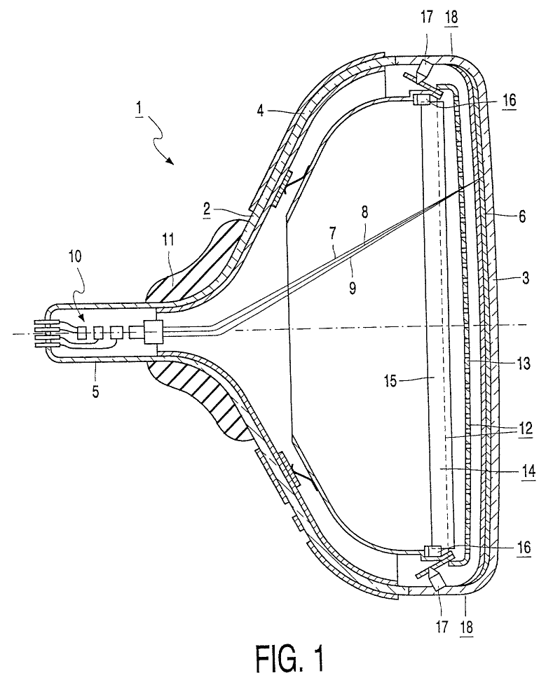

FIG. 1 is a sectional view of a colour display tube according to the invention;

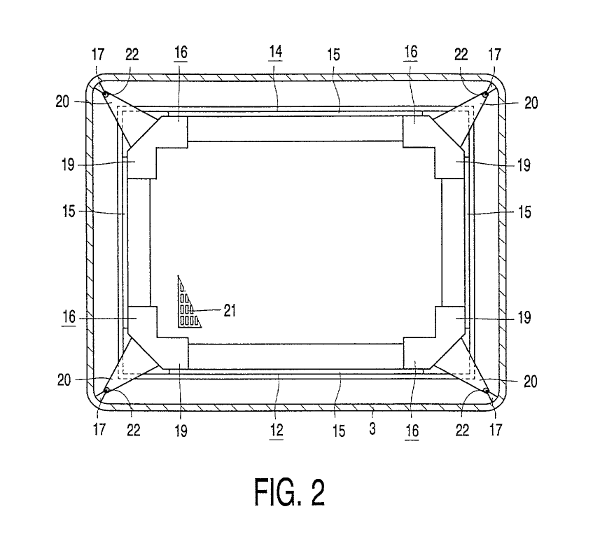

FIG. 2 is a schematic and elevational view of a colour selection electrode mounted in a display window;

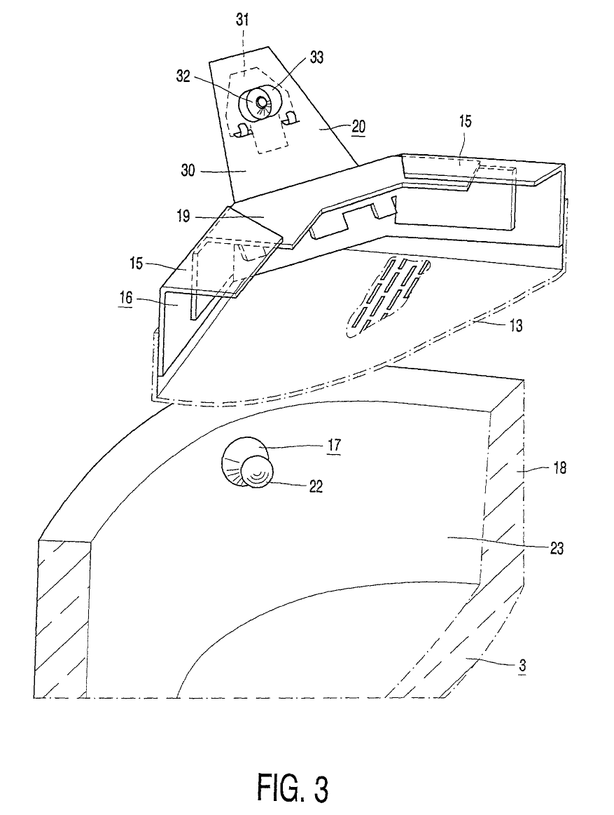

FIG. 3 is a sectional view of a portion of a tube like that of FIG. 1 showing the prior art suspension of a colour selection electrode;

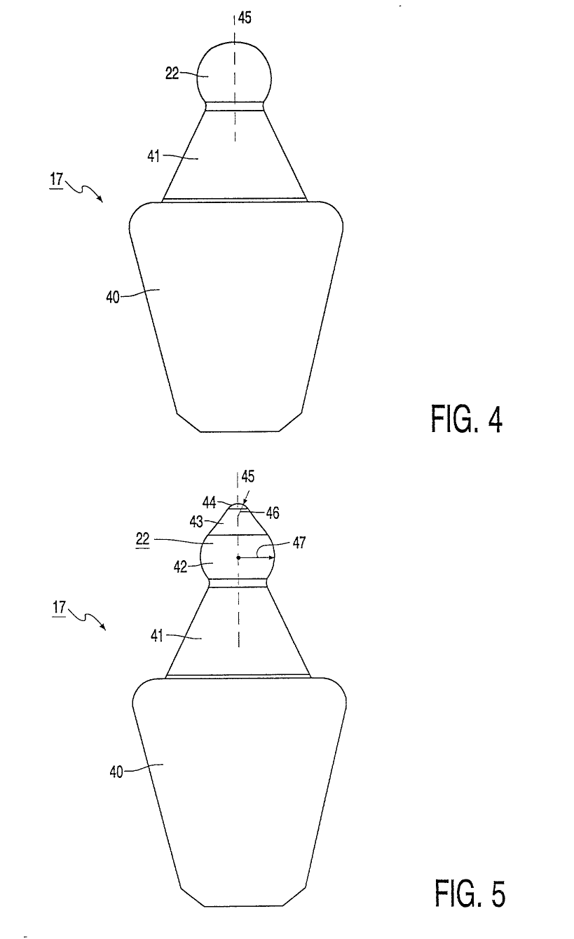

FIG. 4 is a detail of the prior art suspension as shown by FIG. 3;

FIG. 5 is a perspective view of the corner area of the display window and the corner section of the colour selection electrode according to the invention;

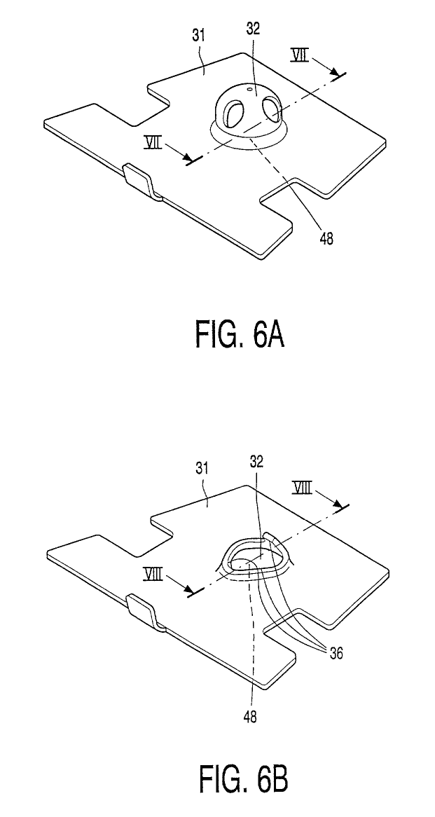

FIGS. 6A-6B are the construction of apertured part, resilient element, spring and supporting element;

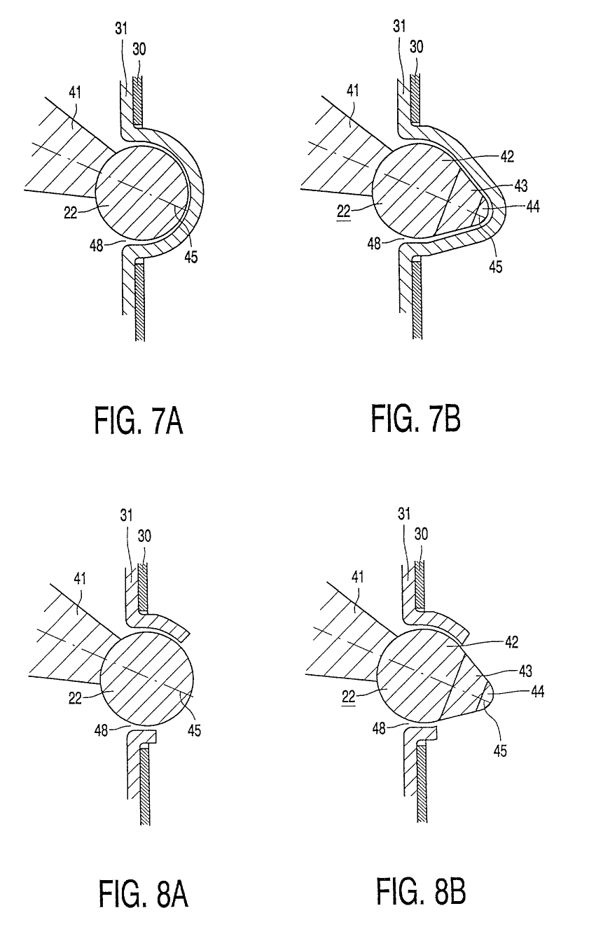

FIGS. 7A-7C are the apertured part, in total (7A) and in detail (7B-7C);

FIG. 8 illustrates the functionality of the self-locking principle;

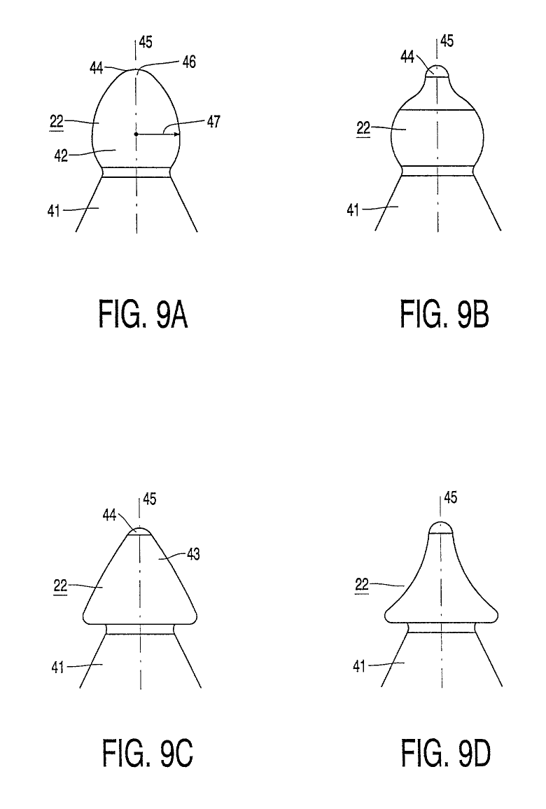

FIG. 9 is an alternative embodiment of the invention.

The colour display tube 1 shown in FIG. 1 comprises an evacuated glass envelope 2 with a display window 3, a funnel shaped part 4 and a neck 5. On the inner side of the display window 3 a screen 6 having a pattern of for example lines or dots of phosphors luminescing in different colours (e.g. red, green and blue) may be arranged. The phosphor pattern is excited by the three electron beams 7, 8 and 9 that are generated by the electron gun 10. On their way to the screen the electron beams 7, 8 and 9 are deflected by the deflection unit 11 ensuring that the electron beams 7, 8 and 9 systematically scan the screen 6. Before the electrons hit the screen 6 they pass through a colour selection electrode 12. This colour selection electrode 12 comprises a shadow mask 13, which is the real colour selective part: it intersects the electron beams so that the electrons only hit the phosphor of the appropriate colour. The shadow mask 13 may be an apertured mask having circular or elongate apertures, or a wire mask. Further, the colour selection electrode 12 comprises the frame 14 for supporting the mask. Parts that can be distinguished in the frame 14 are, amongst others, the corner sections 16 and the diaphragm parts 15, interconnecting the corner sections 16.

The colour selection electrode 12 is suspended from the display window 3 by using supporting elements 17, which are secured in the upright edge of the corner areas 18 of the display window 3. This way of suspending the colour selection electrode 12 in a colour display tube 1 will further be referred to as corner suspension.

In FIG. 2 a schematic and elevational view of a colour selection electrode 12 mounted in a display window 3 is given. The corner sections 16 in this Figure comprise two major portions, a rigid portion 19 for interconnecting the diaphragm parts 15 and a suspension element 20 for suspending the colour selection electrode 12 from the supporting elements 17 in the display window 3. The shadow mask 13 is coupled to the diaphragm parts 15. The section 21 of the mask as indicated in FIG. 2 is only meant as an example. During the manufacturing process the colour selection electrode 12 has to be inserted into and extracted from the display window 3 several times, amongst others for the processes that deposit the matrix and phosphor layers. In order to fulfil the demands regarding the required accuracy of the matrix and phosphor patterns, it is necessary that the position of the colour selection electrode 12 can be reproduced very accurately when it is inserted again. This requires a high positional stability of the colour selection electrode 12 in the colour display tube 1.

In FIG. 3 and 4 the prior art suspension as disclosed in U.S. Pat. No 4,763,039 is given. The supporting element 17 is coupled to the upright edge of the display window 3 and is provided with a free end portion 22 for suspending the colour selection electrode 12 by means of the suspension means 20. These suspension means 20 comprises a resilient element 26 and an apertured part 24 protruding through an aperture 25 in the resilient element 26. This suspension means 20 engages the free end portion in contact points 29 which, in this embodiment, are all located—indicated by the dashed line—at a position outside the plane through the resilient element 26. The apertured part 24 acts as a detent, in this way locking the suspension means 20 to the free end portion 22 of which the centre 23 is substantially coinciding with the plane 47 of the resilient element 26. The upright retaining wall 27 makes that the entrance opening 28 of the apertured part 24 is smaller than the diameter of the free end portion 22. When mounting the colour selection electrode 12 it has to be clamped over the free end portions 22. The colour selection electrode 12 is locked at all four comers to the supporting elements 17 by the spring action of the upright retaining wall 27.

The disadvantage of the system disclosed in U.S. Pat. No. 4,763,039 is its complex structure of the suspension means 20 and the fact that at all four comers the suspension means 20 are locked individually to the supporting elements, which makes the handling of the colour selection very difficult, because during the processing of the screen—applying, for instance, a black matrix and phosphor layers—the colour selection electrode 12 has to be inserted and extracted several times.

A detailed view of the corner area 18 of the display window 3 and the corner section 16 of the colour selection electrode 12 is given in FIG. 5. The suspension means 20 comprise a flat resilient element 30 to which a flat part 31 is coupled. This flat part incorporates an apertured part 32 for engaging the free end portion 22 of the supporting element 17. The flat part 31 is positioned with respect to the resilient element 30 by the oblong aperture 33 in the resilient element 30 through which the apertured part 32 protrudes and by the supporting lip 34 of the flat part 31 penetrating through the slit-shaped aperture 35. The resilient element 30 has been provided with a wire-wound spring 40 (see FIG. 6) in order to make sure that the colour selection electrode 12 is mounted in the display window 3 with a force that guaranties a reliable connection between the colour selection electrode 12 and the supporting elements 17. The ends 37 of the spring 40 are protruding through apertures 36 in the resilient element 30 to simultaneously hold the flat portion 31, while the other end 41 of the spring 40 is connected to the rigid portion 19.

FIGS. 6A and 6B give a perspective view of the suspension means 20, that is, the resilient element 30, the flat portion 31 and the wire wound spring 40, as described in the preceding paragraph for FIG. 5. The FIGS. 6A and 6B give a more detailed impression, for clarity reasons also including the supporting element 17 positioned in the apertured portion 32. The flat portion 31 can shift with respect to the resilient element 30; this freedom is used for compensating small errors in, for instance, the positioning of the supporting elements 17 in the upright edge 18. After the colour selection electrode 12 has been inserted into the display window 3 for the first time the flat portion 31 is rigidly secured to the resilient element 30, which may be done by welding.

A detailed illustration of the flat portion 31 is given by the FIGS. 7A-7C. FIG. 7A gives the entire flat portion, while FIGS. 7B and 7C show that part of the flat portion 31 in which the apertured part 32 is. By way of example, the apertured part 32 of this embodiment is provided with three surfaces of engagement 42, 43. At these surfaces of engagement the free end portion 22 makes contact—when the colour selection electrode 12 is mounted in the display window 3—with the contact points 44, 45. Two of the contact points 45 are located in the plane of the flat portion 31 and the corresponding surfaces of engagement are perpendicular to this plane. The third contact point 44 is outside the plane of the flat portion 31 and the corresponding surface of engagement is oriented at some oblique angle with respect to said plane, such that the direction perpendicular to the surface of engagement is substantially the same as the direction connecting the contact point 44 with the centre 23 of the free end portion 22 (not shown in the Figure).

FIG. 7C shows the apertured part 32 from the side where the free end portion 22 will penetrate. The dimensions of the entrance opening 46 are such that the free end portion can freely pass this opening. The surface of engagement 42 will prevent that the free end portion will pass the apertured part too far and takes care for positioning the free end portion 22 against the three surfaces of engagement 42, 43 at the contact points 44, 45. This enables mounting of the colour selection electrode 12 on the supporting elements 17 without applying clamping forces, and so without creating loose particles. The friction between supporting element 17 and the suspension means 20 remains low, ensuring a good positional stability of the colour selection electrode 12.

The self-locking principle of this suspension system is illustrated in the FIGS. 8. FIGS. 8A, 8B and 8C are a cross-section of the flat portion 31 taken over the line VIII indicated in FIG. 7A. Due to the fact that the apertured part 32 is slightly triangularly shaped in order to obtain three contact points 44, 45, the free end portion 22 does not make contact with the apertured part 32 in the cross-section at a location opposite the contact point 44. The self-locking principle is based on the fact that a contact—for instance, between the free end portion 22 and a surface of engagement 42, 43—works independent from friction as long as the force stays perpendicular to the contact surface.

In general, a colour display tube 1 is most sensitive to shocks when it is oriented with the display window 3 down. Although, this is of course not a viewing condition, this situation should be taken into account, because it occurs during production and transportation. In this case, when the colour display tube 1 is in rest, only the force of gravity acts on it. In FIG. 8A the force of gravity is indicated by F_{g}. In the self-locking construction given as an example by FIGS. 6 and 7—that is with two contact points 45 in the plane 47 of the resilient element 30 and one contact point 44 outside that plane 47—only the action of contact point 44 depends on the friction between the free end portion 22 and the surface of engagement 42. The forces on the contact points 45 are oriented in the plane 47 of the resilient element 30 and can not lead to a displacement of the suspension means 20 with respect to the free end portion 22 that is transverse to the plane 47. In order to make sure that in rest the colour selection electrode 12 does not come free from the supporting elements the friction force must be larger than the force of gravity. This is realized when friction coefficient μ is larger than tan(α) with a as indicated in FIG. 8A.

In case the colour display tube 1 is exposed to a shock from the outside, an additional force acts on the resilient element 30, which force is oriented in the plane 47 through the resilient element 30. This additional force is indicated by F in FIG. 8A. If this force is large enough it will exceed the friction in the contact point 44 between the free end portion 22 and the surface of engagement 42 and the surface of engagement 42 will no longer lock the free end portion 22. As a consequence the suspension means 20 will slip off from the free end portion until the shift is stopped by the surface of engagement 48 (see also FIG. 7C) in the upright wall of the entrance opening 46; this situation is given in FIG. 8B. Reaching this position the contact between the free end portion 22 and the surface of engagement 48 works now independent from the friction between them. The preload of the suspension means 20, which is caused by the resilient element 20 and the spring 40 now takes care that the suspension means are repositioned with respect to the free end portion 22, establishing the original situation as given by FIG. 8C.

This self-locking action as illustrated by FIG. 8 can be summarized by the words ‘slipping’ (FIG. 8A), ‘locking’ (FIG. 8B) and ‘repositioning’ (FIG. 8C).

The suspension of the colour selection electrode 12 by making use of a self-locking suspension means 20 fulfils the requirements with respect to a good positional stability, because no clamping forces are present between the free end portions 22 and the suspension means 20, keeping the friction forces between them at a low level. Further, this self locking system makes it superfluous to rigidly secure, for instance by welding, the suspension means 20 to the free end portions 22. This makes it possible to reclaim the colour selection electrode 20 in case of a reject of the colour display tube 1 and reuse it, what leads to cost savings in the production process.

It will be clear to a person skilled in the art that this invention is not limited to the examples given here. Alternative measures and embodiments for creating a self-locking suspension system will reach the same objectives. An example of an alternative embodiment is given in FIGS. 9. FIG. 9A gives a part of the suspension means 20. The flat portion 31 with the apertured part 32 has been replaced by the washer plate 60. As is apparent from the FIGS. 9B and 9C, the function of the surfaces of engagement 43 is transferred to the edges 62 of the washer plate 60 and the function of the surfaces of engagement 42 is taken over by the edge 61 of the washer plate 60. FIG. 9B gives the rest situation; after applying a force F in the direction of the resilient element 30, the situation of FIG. 9C occurs, where the free end portion 22 is locked against the edge 63 of the resilient element. The preload of the resilient element 30 and the spring 40 will reposition the suspension means 20 to its original position. This construction is somewhat less favourable than the preferred one, because in the ‘locking’ position of FIG. 9B an angle β remains between the plane 47 of the resilient element 30 and the line through the contact point 63 and the centre 23 of the free end portion 22, which makes the self-locking function somewhat weaker.

Further, the invention is not limited to a colour selection electrode 12 having a corner suspension system comprising corner sections 16 and diaphragm parts 15. The invention is, for instance, also applicable on a corner suspension system comprising a ring-shaped frame with suspension elements coupled to this frame.

The invention has been described for a suspension system in which the free end portion 22 is coupled to the supporting element 17 and in which the self locking construction is part of the suspension means 20. Evidently, the invention can also be applied for suspension systems with a self-locking system coupled to the supporting means and a free end portion coupled to the suspension means.

In summary, a colour display tube 1 is disclosed with an improved suspension system of the colour selection electrode 12. The colour display tube has suspension means that have a self-locking construction. The suspension means 20 are provided with an additional flat portion 31. This plate has an aperture 32 that is shaped such that it has at least three surfaces of engagement 42, 43 for the free end portion 22 of the supporting elements 17 which are connected to the inside of the upright edge 18 of the display window 3. When the colour display tube is exposed to a shock the construction of the flat portion 31 is capable of absorbing this shock without the colour selection electrode 12 coming down from the supporting elements 17. The action is based on the friction between the surfaces of engagement 42 and the free end portion 22. When a force is applied in the plane 47 of the resilient element 30, the suspension means 20 slip off from their rest position and are locked by a surface of engagement 48, the preload caused by the resilient element 30 and the spring 40 will reposition the suspension means 20 to its original position. A colour display tube 1 results with good positional stability of the colour selection electrode 12. Further, the colour selection electrode 12 can be reclaimed in case the colour display tube 1 is rejected because there is no need to weld the suspension means 20 to the free end portions 22 anymore.

1. A colour display tube (1) comprising a display window (3) with a circumferential upright edge and corner areas (18), a colour selection electrode (12) comprising corner sections (16) to which suspension means (20), comprising a resilient element (30) having a flat portion (31) incorporating an apertured part (32) with an entrance opening ( ), are coupled, which colour selection electrode (12) is suspended in the corner areas (18) from supporting elements (17) each having a free end portion (22) engaging the apertured part (32) at at least three contact points (44,45) which are located on surfaces of engagement (42,43), the free end portion (22) having a centre (23) which is substantially coinciding with a plane (47) through the resilient element (30), the apertured part (32) being so formed that at least one of the contact points (44) is situated out of the plane (47) of the resilient element (30), on the side thereof directed away from the free end portion (22), characterized in that the surfaces of engagement (43) of contact points (45) that coincide with the plane (47) of the resilient element (30) are substantially perpendicular to said plane (47) and the surfaces of engagement (42) of contact points (44) that are situated out of said plane (47) are substantially perpendicular to the connection between the contact point (44) and the centre (23) of the free end portion (22), which free end portion (22) is suitable for freely passing the entrance opening (46) of the apertured part (32).

2. A colour display tube (1) as claimed in claim 1, characterized in that the apertured part (32) being so formed that the coupling between the apertured part (32) and the free end portion (22) is self locking for forces applied in the direction of the flat portion (31).

3. A colour display tube (1) as claimed in claim 1 or 2, characterized in that a friction force arises between the surfaces of engagement of the contact points that are situated out of the plane (47) of the flat portion (31) and the free end portion (22) when a force is applied in the direction of the flat portion (31).

4. A colour display tube (1) as claimed in claim 1, 2 or 3, characterized in that one contact point (44) is situated out of the plane (47) of the resilient element (30) and two contact points (42) are substantially coinciding with said plane (47).

5. A colour display tube (1) as claimed in claim 1, 2, 3 or 4, characterized in that the free end portions (22) are substantially spherically curved.

6. A corner section (16) for use in a colour selection electrode (12) of a colour display tube (1), having suspension means (20), comprising a resilient element (30) having a flat portion (31) incorporating an apertured part (32) with an entrance opening (46), the apertured part (32) further comprising at least three surfaces of engagement, said corner section (16) being suitable for coupling it to free end portions (22) of supporting elements (17) secured to corner areas (18) of the display window (3) such that the surfaces of engagement (42,43) will engage the free end portions (22) at contact points (44,45), the apertured part (32) being so formed that at least one of the contact points (44) is situated out of the plane (47) of the resilient element (30), on the side thereof directed away from the free end portion (22), characterized in that the surfaces of engagement (43) of contact points (45) that coincide with the plane (47) of the resilient element (30) are substantially perpendicular to said plane (47) and the surfaces of engagement (42) of contact points (44) that are situated out of said plane (47) are substantially perpendicular to the connection between the contact point (44) and the centre (23) of the free end portion (22), which free end portion (22) is suitable for freely passing the entrance opening (46) of the apertured part (32).

7. A corner section (16) as claimed in claim 6, characterized in that one contact point (44) is situated out of the plane (47) of the resilient element (30) and two contact points (45) are substantially coinciding with said plane (47).

8. A colour selection electrode (12) provided with the corner section (16) as claimed in claim 6 or 7.
